(19) United States
(12) Patent Application Publication
(10) Pub. No.: US 2008/0320490 A1
(43) Pub. Date: Dec. 25, 2008

(54) METHOD, APPARATUS AND COMPUTER PROGRAM PRODUCT FOR PROVIDING SUB-PROCESS RESOURCE MANAGEMENT

(75) Inventors: Jozsef Biro, Budapest (HU); Daniel Fey, Budapest (HU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/765,793

(22) Filed: Jun. 20, 2007

(51) Int. Cl. G06F 13/00

(52) U.S. Cl. 719/313

(57) ABSTRACT

An apparatus for providing sub-process resource management includes a processing element. The processing element may be configured to communicate with a process being executed by an operating system, to receive information regarding a resource associated with an isolated sub-process within the process, to establish an association between the resource and the isolated sub-process, and to perform sub-process resource management based on the received information.

TECHNOLOGICAL FIELD

Embodiments of the present invention relate generally to runtimes such as virtual machines, and, more particularly, relate to a method, apparatus, and computer program product for providing resource management in a runtime such as a virtual machine.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer and convenience to users relates to provision of various applications or software to users of electronic devices such as a mobile terminal. The applications or software may be executed from a local computer, a network server or other network device, or from the mobile terminal such as, for example, a mobile telephone, a mobile television, a mobile gaming system, etc, or even from a combination of the mobile terminal and the network device. In this regard, various applications and software have been developed and continue to be developed in order to give the users robust capabilities to perform tasks, communicate, entertain themselves, etc. in either fixed or mobile environments. However, many electronic devices which have different operating systems may require different versions of a particular application to be developed in order to permit operation of the particular application at each different type of electronic device. If such different versions were developed to correspond to each different operating system, the cost of developing software and applications would be increased.

Accordingly, runtimes such as, for example, virtual machines (VMs) have been developed. A VM is a self-contained operating environment that behaves as if it is a separate computer. The VM may itself be a piece of computer software that isolates the application being used by the user from the host computer or operating system. For example, Java applets running in a Java VM (JVM) have no direct access to the services of the host operating system. Because versions of the VM are written for various computer platforms, any application written for the VM can be operated on any of the platforms, instead of having to produce separate versions of the application for each computer and operating system. The application may then be run on a computer using, for example, an interpreter such as Java. Java, which is well known in the industry, is extremely portable, flexible and powerful with respect to allowing applications to, for example, access mobile phone features. Thus, Java has been widely used by developers to develop portable applications that can be run on a wide variety of electronic devices or computers without modification.

A common architectural paradigm in software systems is the layered architecture in which software layers are separated by well-defined interfaces. For example, a lower layer may provide basic functions for an upper layer that provides a more complex service using the basic functions of the underlying layer as building blocks. The interface between the two layers hides the complexity of the lower layer from the upper layer and provides a simplified view. Furthermore, in multilayered architectures, an interface may hide other or even all of the layers that are further below. The topmost layer is often referred to as the application layer, which employs the capabilities of the underlying layer to perform a task for the user. There are several terms that may be used to refer to the underlying layer (or more precisely the set of all underlying layers) such as, for example, system software, platform or execution environment. As opposed to the application layer, the execution environment coordinates system capabilities but does not directly implement tasks for the benefit of the user. A classic example of an execution environment is an operating system that manages the hardware and software resources of a computer. Another more recent example of an execution environment is the runtime of which the virtual machine is an example. The JVM and the Common Language Runtime (CLR) are very common examples of runtimes.

In the layered approach described above, a runtime such as a JVM may be considered as an application from the point of view of the underlying operating system, whereas the JVM may be considered as an execution environment from the point of view of a Java application. With the emergence of various complex Java container frameworks, the borderline between applications and the execution environment may be shifted from the previous paradigm. For example, the Java framework is typically a classic Java application from the point of view of the JVM, whereas the Java framework may be considered an execution environment for applications conforming to the model defined by the framework.

A key property of any execution environment is the application model it supports. In this regard, an application model may specify the application lifecycle (e.g., how and when applications are started and stopped), what are the possible special application states (e.g. suspended), how the applications interact with the execution environment or with each other, and so on. Accordingly, the number of applications executing at the same time and the level of isolation between the applications may be relevant aspects to consider.

Modern operating systems often support multiple applications and provide strong isolation between the applications. The rationale for the strong isolation is that applications may be independent from each other insofar as they may belong to different users and may derive from different sources. Therefore, ensuring the flawless operation of an application without any interference from another concurrently executing application is an important aspect. A traditional JVM may represent a different situation since it may support only a single Java application. However, in order to support multiple independent applications, a new type of JVM has been introduced recently which may support multiple Java applications and provides more or less the same level of isolation as an operating system with respect to the Java applications. An example of a JVM that may be capable of supporting multiple Java applications may be referred to as a multi-tasking virtual machine (MVM).

Java container frameworks represent a somewhat different approach to multi-application support in Java. With this approach, applications may be deployed into and executed within a container, which provides a controlled environment (and thus a different model) for the applications. The container may itself be a Java program executing in the (single-application) JVM and utilizing JVM features in order to provide isolation for the applications. However, the isolation provided by such container frameworks is usually much less effective than the isolation provided by the operating system or by an MVM.

A key functionality of execution environments may be the handling of resources. A resource may be generically defined as a measurable entity that an application utilizes such that a shortfall in the measurable entity results in a performance change. Typical examples of resources in software systems are memory, CPU time and execution threads, file handles, sockets, etc. In some software environments, more complex software resources are composed of basic resources. The handling of resources may be classified into two levels. The first level may represent basic handling of resources that must be present in any execution environment. Operations supported at this level usually include the allocation, use and release of resources by applications and mechanisms to ensure the consistent state of resources (and thus the consistent state of applications using them).

The second level may be referred to as resource management. Resource management may apply to features like resource usage accounting, enforcing resource usage limits, resource reclamation, fair and priority based resource distribution, etc. Resource accounting means that the environment is able to determine the amount of resources used by the currently executing applications. A typical way of enforcing usage limits is that the environment is able to refuse resource allocation requests if the application exceeds its quota with respect to the resource. Resource reclamation is important for the proper implementation of forceful termination of applications, as otherwise the resources reserved by the terminated application may be used again. Fair and priority based resource distribution may provide that every application receives a deserved share of resources (based on equality or on rank). In general, the purpose of resource management is to provide additional protection to the system by preventing system failures because of Denial of Service attacks or faulty applications. Resource management also aims to ensure the long-term operation of the system by the efficient reclamation of resources and long-term operation of critical applications by guaranteeing the necessary resources to them.

In multi-application environments, the application model may define the application entity type that can act as the “owner” of resources offered by the execution environment. For instance, in mainstream operating systems the entity type may be a process which in some cases is roughly equivalent to an application, although in other cases more processes may cooperate and form a more complex application. In an operating system, processes are therefore the subject of all aforementioned resource management activities.

In order to provide application isolation and resource management in runtime execution environments, a certain level of support from the operating system may be required. However, such support is not currently available in mainstream mobile, desktop and server operating systems. As such, at the operating system level, the main subject of application isolation and resource management is the process. The Java execution environment (i.e. the JVM, and the Java framework, if any) is such a process itself (e.g., the JVM may be considered a single application from the point of view of the operating system). Thus, the operating system may not recognize that the Java process is itself an execution environment executing several Java applications. Since the operating system does not know anything about the applications within the process (e.g., the JVM), it does not provide any isolation or resource management service to these applications.

Particularly in mobile environments where resources are scarce due to consumer demand to reduce the cost and size of mobile terminals, it may be important to manage resources such as by conservation or reuse of the resources. Accordingly, it may be desirable to provide a mechanism for overcoming at least some of the shortcomings described above.

### BRIEF SUMMARY

A method, apparatus and computer program product are therefore provided for providing resource management at a sub-process level. In particular, a method, apparatus and computer program product are provided that enable management of resources associated with applications associated with a particular runtime or VM. Accordingly, rather than being limited to resource management at the process level (e.g., at the level of a runtime or VM), resource management may be accomplished at the sub-process level (e.g., for applications within an execution environment). Thus, embodiments of the present invention may provide a mechanism by which to implement both isolation and resource management functionalities within an execution environment running in a single operating system process.

In one exemplary embodiment, a method of providing resource management at a sub-process level is provided. The method may include communicating with a process being executed by an operating system, receiving information regarding a resource associated with an isolated sub-process within the process, establishing an association between the resource and the isolated sub-process, and performing sub-process resource management based on the received information.

In another exemplary embodiment, a computer program product for providing resource management at a sub-process level is provided. The computer program product includes at least one computer-readable storage medium having computer-readable program code portions stored therein. The computer-readable program code portions include first, second, third and fourth executable portions. The first executable portion is for communicating with a process being executed by an operating system. The second executable portion is for receiving information regarding a resource associated with an isolated sub-process within the process. The third executable portion is for establishing an association between the resource and the isolated sub-process. The fourth executable portion is for performing sub-process resource management based on the received information.

In another exemplary embodiment, an apparatus for providing resource management at a sub-process level is provided. The apparatus may include a processing element. The processing element may be configured to communicate with a process being executed by an operating system, to receive information regarding a resource associated with an isolated sub-process within the process, to establish an association between the resource and the isolated sub-process, and to perform sub-process resource management based on the received information.

In another exemplary embodiment, an apparatus for providing resource management at a sub-process level is provided. The apparatus includes means for communicating with a process being executed by an operating system, means for receiving information regarding a resource associated with an isolated sub-process within the process, means for establishing an association between the resource and the isolated sub-process, and means for performing sub-process resource management based on the received information.

Embodiments of the invention may provide a method, apparatus and computer program product for providing resource management while still providing isolation and may be used, for example, in a virtual machine or other runtime. Although embodiments of the invention may be advantageously employed in mobile environments such as limited resource devices, embodiments of the invention may also be employed in devices having virtually unlimited resources.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 illustrates a block diagram of elements of a system for providing resource management at a sub-process level according to an exemplary embodiment of the present invention; and

FIG. 3 is a flowchart according to an exemplary method of providing sub-process resource management according to one embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

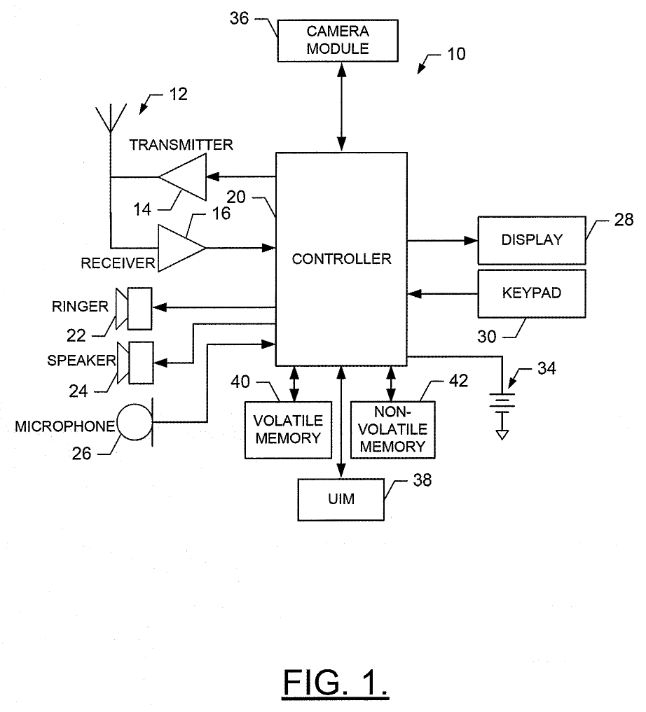

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer 22, a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In an exemplary embodiment, the mobile terminal 10 includes a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may include a digital camera capable of forming a digital image file from a captured image. As such, the camera module 36 includes all hardware, such as a lens or other optical component(s), and software necessary for creating a digital image file from a captured image. Alternatively, the camera module 36 may include only the hardware needed to view an image, while a memory device of the mobile terminal 10 stores instructions for execution by the controller 20 in the form of software necessary to create a digital image file from a captured image. In an exemplary embodiment, the camera module 36 may further include a processing element such as a co-processor which assists the controller 20 in processing image data and an encoder and/or decoder for compressing and/or decompressing image data. The encoder and/or decoder may encode and/or decode according to a JPEG standard format.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

Although FIG. 1 illustrates an example of a mobile terminal which may utilize embodiments of the present invention, it should be understood that the mobile terminal 10 of FIG. 1 is merely an exemplary device that may utilize embodiments of the present invention. Generally speaking, any device having a processing element capable of employing an operating system for execution of applications or processes may utilize embodiments of the present invention. In this regard, for example, such a device may typically also include or otherwise be in communication with a memory device and may also include some form of user interface. A processing element such as those described above may be embodied in many ways. For example, the processing element may be embodied as a processor, a coprocessor, a controller or various other processing means or devices including integrated circuits such as, for example, an ASIC (application specific integrated circuit).

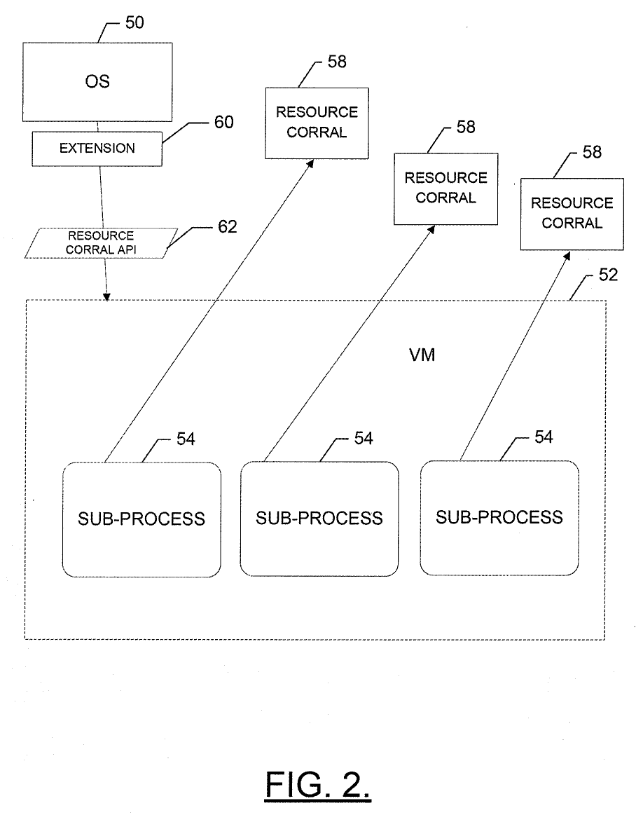

An exemplary embodiment of the invention will now be described with reference to FIG. 2, in which certain elements of a system for providing resource management at a sub-process level (e.g., for applications within in a runtime or VM capable of serving as an execution environment for multiple applications such as an MVM) are displayed. The system illustrated in FIG. 2 may be resident on, for example, the mobile terminal 10 of FIG. 1. As shown in FIG. 2, the system may include an operating system (OS) 50 that may be capable of executing a plurality of processes or applications. For example, one such application or process that the OS 50 may be configured to execute may be a runtime (e.g., VM 52) that is capable of serving as an execution environment for multiple applications or sub-processes 54.

The OS 50 may include a set of computer programs that handle the hardware and software resources of a computer or device such as the mobile terminal 10. The OS may be configured to process raw system and user input and to respond by allocating and managing tasks and internal system resources as a service to users and the programs (e.g., applications or processes) of the system. At the foundation of all system software, the OS may perform basic tasks such as controlling and allocating memory, prioritizing system requests, controlling input and output devices, facilitating networking, managing file systems and the like.

The VM 52 may also include one or more applications (e.g., sub-processes 54) or application programming interfaces (APIs). The applications and/or APIs may each include code segments that at least in part define the corresponding applications and/or APIs. Code segments may be classified at various levels, such as by method, class, package, etc. or combinations of the previously mentioned levels. The VM 52 may run, for example, on a framework of the mobile terminal 10 of FIG. 1. The framework of the mobile terminal may include the operating system (e.g., OS 50) of the mobile terminal 10. It should be noted, however, that while FIG. 2 illustrates merely one example of a configuration of a runtime in the form of a VM, numerous other configurations may also be used to implement embodiments of the present invention. It should also be noted that while the VM 52 of FIG. 2 may be a Java VM, any other operating system or VM may also be used. Furthermore, the OS 50 and/or the VM 52 of FIG. 2 may alternatively be embodied as any device or means embodied in either hardware, software, or a combination of hardware and software that is capable of acting as an execution environment and managing hardware and/or software resources of a device (in the case of the OS 50) or a VM (in the case of the VM 52) as described above. In an exemplary embodiment, however, the OS 50 and the VM 52 may be embodied in software as instructions that are stored on a memory of the mobile terminal 10.

In a typical environment, the OS 50 may include resource management functionality configured to perform resource management at the process level, but which is unable to see which resources are associated with a particular one of the sub-processes 54. In other words, for example, if memory is consumed in connection with the execution of a particular process, the OS 50 may manage the consumption of the memory such that if the process is closed or terminated, the memory may be recovered. However, if one sub-process of the VM 52 consumes a particular set of memory pages and the sub-process is closed or terminated by the VM 52, the OS 50 cannot typically see which memory pages were associated with the closed or terminated sub-process and therefore the OS 50 cannot reuse the particular set of memory pages. However, according to embodiments of the present invention, a sub-process entity may be associated with each of the sub-processes 54 which enables resource management within a runtime such as the VM 52. In this regard, there may be one or more sub-process entities associated with each corresponding one of the sub-processes 54.

The sub-process entity according to an exemplary embodiment of the present invention may be configured to collect related resources associated with a particular one of the sub-processes 54. A resource corral 58 may be in communication with or otherwise be embodied as the sub-process entity. In other words, in one embodiment, the sub-process entity may not exist and any functions or characteristics associated with the sub-process entity may be performed or embodied by the resource corral 58. In an exemplary embodiment, the resource corral 58 may be a logical construct that maps resources to particular applications or sub-processes (e.g., the sub-processes 54) by including the sub-process entities associated with a particular one of the sub-processes 54. In other words, in one embodiment, the sub-process entities may each be associated with a particular resource associated with a particular sub-process and thus, the resource corral 58 may, by including all the sub-process entities associated with the particular sub-process, include all the resources associated with the particular sub-process. Thus, the resource corral 58 according to this example may be a subset of resources including the resources allocated by a process (e.g., the VM 52) for a particular application (e.g., one of the sub-processes 54). The resource corral 58 may be created via an extension 60 to the OS 50 (e.g., a kernel) coupled with a user space API (e.g., a resource corral API 62). In this regard, the resource corral API 62 may act as a communication channel between the extension 60 (which is an OS kernel extension) and a multi-application runtime (e.g., VM 52). As such, the resource corral may provide support for implementing isolation and resource management functionalities within an execution environment running in a single OS process.

The extension 60 may include code forming an extension to the OS 50. The extension 60 may be configurable using the resource corral API 62, for example, to apply a scheme to associate resources with the resource corral 58 automatically based on other information. In this regard, for example, the extension 60 may be configured to automatically associate resources with the resource corral 58 based on context information. In an exemplary embodiment, the extension 60 may be configured to automatically associate resources with the resource corral 58 based on thread context information, which may be available at the OS level. However, other types of context information could alternatively be used for automating resource association. In this regard, for example, the extension 60 may be configurable using the resource corral API 62 to enable a runtime (e.g., the VM 52) to select and/or modify one of a predetermined set of schemes for resource association with the resource corral. In an exemplary embodiment, the selection/modification may be made based on the application model associated with the sub-process or application for which the resource association is being performed. The extension 60 may also be configured to detect whether an associated resource has been released and remove the corresponding resource from the resource corral 58. In an exemplary embodiment, the extension 60 may be configured to apply resource management policies such as resource usage accounting, resource usage limiting, and the like, for certain resources. Resources handled by the extension 60 may include any or all of the resources visible at the OS level (e.g., memory, threads, input/output resources, etc.).

The extension 60 may add a memory management layer in some embodiments. In this regard, if the OS 50 supports memory paging, then the extension 60, based on a request from the execution environment (e.g., the VM 52), may be capable of dedicating separate virtual memory address spaces to resource corrals. Thus, it may be possible to restrict the number of physical pages allocated to the dedicated virtual memory address spaces, for example, via minor modifications in a memory management subsystem of the OS kernel. Accordingly, the task of measuring and limiting the amount of memory consumed by an application embedded within a multi-application Java environment may be simplified.

Resource corrals may be dynamically created and/or finalized during the process lifecycle, for example, via the resource corral API 62. In this regard, when an application or sub-process is terminated or closed by the runtime, all resources associated with the application or sub-process (e.g., all resources in the resource corral 58) may be released and the corresponding resource corral may be freed also during finalization. Creation of a default resource corral may be automatically performed when a process is created. Alternatively, by default there may be no resource corral created unless the process created is a process for which a resource corral may be useful. For example, for a typical process or application (e.g., Word, Excel, etc.) that is not a runtime, there may be no benefit to creating a default resource corral. However, if the process created corresponds to a managed runtime, a default resource corral may then be created, when a process is created, to associate resources that do not belong to any sub-process of the managed runtime.

As indicated above, resources may be added to the resource corral 58 by associating a resource with a corresponding sub-process. In an exemplary embodiment, the association of resources may be performed via the resource corral API 62. Accordingly, for example, the VM 52 may be considered to have the responsibility for determining which resources are associated with a resource corral and not the OS 50. In an exemplary embodiment, the association of resources to a particular sub-process may be accomplished by adding a file descriptor to the resource corral 58 using the resource corral API 62. In this regard, for example, the resource corral 58 may collect resources associated with an independent or isolated activity (e.g., application or sub-process) within a process (e.g., the VM 52). As such, an isolated sub-process may be defined as a process or application being executed within the execution environment of an OS process.

The extension 60 and the resource corral API 62 may provide several functionalities associated with the resource corral 58. In this regard, for example, some functionalities provided may include creating a new resource corral, associating a resource with the resource corral, configuring a resource corral to automatically associate newly allocated resources based on context information, configuring a resource corral for resource management, and finalizing a resource corral (e.g., automatically releasing associated resources when the corresponding sub-process is closed or terminated).

Notably, embodiments of the present invention may be practiced largely without changing the semantics of an OS process. Accordingly, at the OS level, the process remains the unit of isolation and resource management. However, the resource corral may provide execution environments like Java (e.g., MVM or other multiple application runtimes) with a mechanism for isolation and resource management of sub-processes executed therein.

Resource management tasks may be shared between the OS 50 and the VM 52. In this regard, for example, an exemplary implementation of an embodiment of the present invention may include an MVM having an isolation API (e.g., Java Specification Request (JSR) 121) that specifies Java isolates (e.g., roughly the Java equivalent of an OS process) as a set of Java threads. The MVM may be configured to automatically associate all resources that are reserved from a particular Java thread with the isolate to which the Java thread belongs. The MVM itself may be implemented such that the Java thread descriptor includes a reference to its “owner” isolate so that the reference may be used for the automatic association of resources. The MVM may request the OS to create a resource corral for an isolate (or for each isolate), to associate threads of the isolate with the resource corral, and to apply automatic resource associations on thread context information. Accordingly, in this particular example, a distribution of tasks between the OS and the MVM may be achieved in which the OS may manage basic resources (e.g., memory, file descriptors, etc.) and the MVM may manage resources specific to the MVM (e.g., Java class variables, Java classes, locks, etc.).

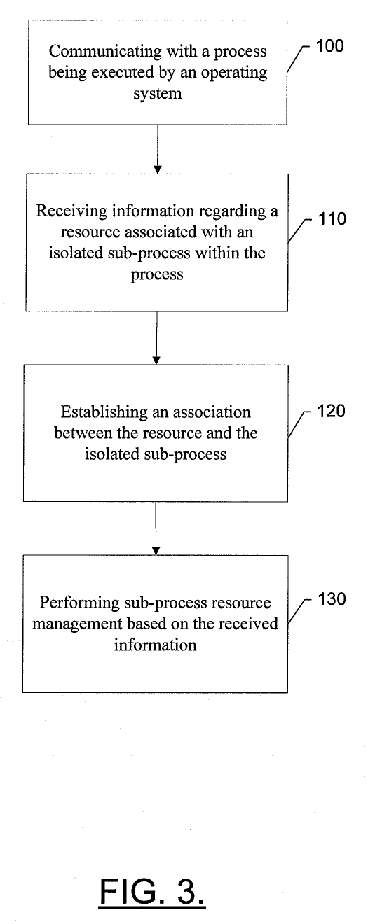

FIG. 3 is a flowchart of a method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method of providing sub-process resource management, as shown in FIG. 3, may include communicating with a process being executed by an operating system at operation 100. In an exemplary embodiment, the process may be a runtime or virtual machine configured to be capable of acting as an execution environment for multiple sub-processes. At operation 110, information regarding a resource associated with an isolated sub-process within the process may be received. An association may be established between the resource and the isolated sub-process at operation 120. Sub-process resource management may then be performed based on the received information at operation 130.

In an exemplary embodiment, operation 120 may include establishing the association based on context information. Operation 120 may also or alternatively include selecting a scheme for resource association from a predetermined set of schemes for resource association. The selected scheme may be modified in some embodiments based on an application model associated with the isolated sub-process. Furthermore, in some cases, the resource association may be performed in response to a determination that the process is a runtime.

In an exemplary embodiment, operation 130 may include configuring a resource corral for resource management of resources specific to a runtime and managing sub-process resources that are not specific to a runtime at the operating system.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
communicating with a process being executed by an operating system;
receiving information regarding a resource associated with an isolated sub-process within the process;
establishing an association between the resource and the isolated sub-process; and
performing sub-process resource management based on the received information.

2. A method according to claim 1, wherein communicating with a process comprises communicating with a runtime configured to be capable of acting as an execution environment for multiple sub-processes.

3. A method according to claim 1, wherein establishing the association comprises establishing the association based on context information.

4. A method according to claim 1, wherein establishing the association comprises selecting a scheme for resource association from a predetermined set of schemes for resource association.

5. A method according to claim 4, further comprising modifying the selected scheme based on an application model associated with the isolated sub-process.

6. A method according to claim 1, wherein establishing the association comprises establishing the association in response to a determination that the process is a runtime.

7. A method according to claim 1, wherein performing sub-process resource management comprises configuring a resource corral for resource management of resources specific to a runtime.

8. A method according to claim 1, wherein performing sub-process resource management comprises managing sub-process resources that are not specific to a runtime at the operating system.

9. A computer program product comprising at least one computer-readable storage medium having computer-readable program code portions stored therein, the computer-readable program code portions comprising:
a first executable portion for communicating with a process being executed by an operating system;
a second executable portion for receiving information regarding a resource associated with an isolated sub-process within the process;
a third executable portion for establishing an association between the resource and the isolated sub-process; and
a fourth executable portion for performing sub-process resource management based on the received information.

10. A computer program product according to claim 9, wherein the first executable portion includes instructions for communicating with a runtime configured to be capable of acting as an execution environment for multiple sub-processes.

11. A computer program product according to claim 9, wherein the third executable portion includes instructions for establishing the association based on context information.

12. A computer program product according to claim 9, wherein the third executable portion includes instructions for selecting a scheme for resource association from a predetermined set of schemes for resource association.

13. A computer program product according to claim 12, further comprising a fifth executable portion for modifying the selected scheme based on an application model associated with the isolated sub-process.

14. A computer program product according to claim 9, wherein the third executable portion includes instructions for establishing the association in response to a determination that the process is a runtime.

15. A computer program product according to claim 9, wherein the fourth executable portion includes instructions for configuring a resource corral for resource management of resources specific to a runtime.

16. A computer program product according to claim 9, wherein the fourth executable portion includes instructions for managing sub-process resources that are not specific to a runtime at the operating system.

17. An apparatus comprising a processing element configured to:
communicate with a process being executed by an operating system;
receive information regarding a resource associated with an isolated sub-process within the process;
establish an association between the resource and the isolated sub-process; and
perform sub-process resource management based on the received information.

18. An apparatus according to claim 17, wherein the process is a runtime and the processing element is further configured to communicate with the runtime, the runtime being configured to be capable of acting as an execution environment for multiple sub-processes.

19. An apparatus according to claim 17, wherein the processing element is further configured to establish the association based on context information.

20. An apparatus according to claim 17, wherein the processing element is further configured to establish the association by selecting a scheme for resource association from a predetermined set of schemes for resource association.

21. An apparatus according to claim 20, wherein the processing element is further configured to modify the selected scheme based on an application model associated with the isolated sub-process.

22. An apparatus according to claim 17, wherein the processing element is further configured to establish the association in response to a determination that the process is a runtime.

23. An apparatus according to claim 17, wherein the processing element is further configured to create a resource corral for resource management of resources specific to a runtime.

24. An apparatus according to claim 17, wherein the processing element is further configured to manage sub-process resources that are not specific to a runtime at the operating system level.

25. An apparatus comprising:
means for communicating with a process being executed by an operating system;
means for receiving information regarding a resource associated with an isolated sub-process within the process;
means for establishing an association between the resource and the isolated sub-process; and
means for performing sub-process resource management based on the received information.

26. An apparatus according to claim 25, wherein the means for communicating with the process comprises means for communicating with a runtime configured to be capable of acting as an execution environment for multiple sub-processes.
